(19) United States
(12) Patent Application Publication
(10) Pub. No.: US 2017/0252623 A1
(43) Pub. Date: Sep. 7, 2017

(54) ICE SKATING TRAINING SYSTEMS

(71) Applicant: CHRISTIAN SHARIFI, WEST VANCOUVER (CA)

(72) Inventor: CHRISTIAN SHARIFI, WEST VANCOUVER (CA)

(21) Appl. No.: 15/058,523

(22) Filed: Mar. 2, 2016

(51) Int. Cl. A63B 69/00; A63B 71/06; A63B 71/00; A63B 24/00; A63B 22/02; G09B 19/00

(52) U.S. Cl. CPC A63B 69/0022; A63B 22/0235; A63B 22/0285; G09B 19/0038; A63B 71/0054; A63B 22/025; A63B 24/0087; A63B 71/0622; A63B 24/0075; A63B 24/0062; A63B 2071/0081; A63B 2022/0278; A63B 2230/75; A63B 2220/20; A63B 2071/0658; A63B 2244/18; A63B 2244/183

(57) ABSTRACT

An ice skating training system including an ice skating training system to allow a user to train and practice ice skating skills. The ice skating training assembly includes a treadmill assembly and a harness assembly. The treadmill assembly includes a frame, a pair of side-support-bars, a pedestal, a computer, an electric-motor, a plurality of bearings, and an artificial ice assembly. The artificial ice assembly includes a plurality of artificial-ice-panels and a plurality of lateral-pins to provide the user with a continuous loop of an ice-like surface. In preferred embodiments each of the plurality of artificial-ice-panels are constructed of an ultra-high-molecular-weight polymer to provide increased longevity and durability during use and the plurality of lateral-pins are constructed of a steel alloy for durability and longevity. Each of the pair of side-support-bars provide the user with a structural member to grasp during use.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of exercise equipment and more specifically relates to ice skating training systems.

2. Description of Related Art

Many individuals participate in various sports and athletic activities that include the use of ice skates. Generally, these types of activities require extensive practice and training in order for the individual to be successful and competitive. There are various methods of training on ice skates, many of which require a surface of ice. This can prove to be difficult to find in warmer regions where the weather does not include times of the year when ice and snow are present.

Outdoor ice skating generally requires a large open area which can be dangerous if the individual is skating on a frozen lake with unknown thickness. Indoor ice skating areas may be available in some areas, but can be expensive to use (rental time) and may have a limited time available for an individual to ice skate and train. Treadmills are often used for individuals to train and exercise running, however it may be desirable for the user to add increased downward resistance in improve the ice skating skills and technique. Therefore a suitable solution is desired.

Several attempts have been made to solve the above-mentioned problems such as those found in U.S. and Foreign Pat. Nos. U.S. Pat. No. 7,854,689 to Blaylock, U.S. Pat. No. 5,385,520 to Lepine et al., U.S. Pat. No. 6,227,759 to Fricke et al., U.S. Pat. No. 7,896,781 to Larson, U.S. Pat. No. 8,118,599 to Lipetz, U.S. Pat. No. 4,169,688 to Toshio, U.S. Pat. No. 8,784,223 to Talafous, CA 2672558 to Mcivor, NL 1,036,882 to Te Grou et al., and CA 2,116,378 to Lee. This art is representative of exercise equipment. However, none of the above inventions and patents, taken either singly or in combination, is seen to describe the invention as claimed.

Preferably, a ice skating training system should provide a safe and effective way for an individual to both train and practice ice skating skills with a variety of programmed drills and, yet would operate reliably and be manufactured at a modest expense. Thus, a need exists for a reliable ice skating training system to avoid the above-mentioned problems.

### BRIEF SUMMARY OF THE INVENTION

In view of the foregoing disadvantages inherent in the known exercise equipment art, the present invention provides a novel ice skating training systems. The general purpose of the present invention, which will be described subsequently in greater detail is to provide an device to allow an individual to exercise and practice ice skating skills in a small area without the need for water-based ice. The present invention serves to increase the ice skating skills and endurance of the user by providing an ice skating simulation for the user.

An ice skating training system is disclosed herein, in a preferred embodiment, the ice skating training system comprising an ice skating training assembly in functional combination. The ice skating training system, in preferred embodiments, comprises a treadmill assembly and a harness assembly. In a preferred embodiment, the treadmill assembly comprises a frame, a pair of side-support-bars, a pedestal, a computer, an electric-motor, a plurality of bearings, and an artificial ice assembly in functional combination.

In preferred embodiments, the electric-motor operates via a 220-volt electrical supply and provides rotative motion to the artificial ice assembly, with the electric-motor being reversible such that the user may practice ice skating skills in an opposite direction. The plurality of bearings are structured and arranged to provide minimal resistance for the artificial ice assembly during use. Each of the pair of side-support-bars provide the user with a structural member to grasp during use.

The computer selectively controls a speed of the electric motor such that the user operates the computer to select a desired speed of the electric motor. Additionally, the computer controls the electric motor to allow the user to select a pre-programmed drill which includes variations of the speed of the electric motor during the drill. In preferred embodiments the computer calculates the number of calories burned by the user and the distance traveled by the user during use. The computer may also include a display such that the user may view the distance traveled and the number of calories burned for reference.

The pedestal is structured and arranged to support the computer, the harness assembly and the safety-tether. The harness assembly comprises the variable-downward resistance, the body-harness, and the safety-tether in functional combination. The safety-tether is structured and arranged to removably affix to the computer such that the user may shut off the power supply by pulling on the safety-tether, with the safety-tether including a clip to allow the user to affix the safety-tether to an article of clothing worn by the user such that if the user was to fall, the safety-tether would be incidentally be pulled, and power supply shut off. The variable-downward-resistance comprises elastic bands to provide a downward force in preferred embodiments.

The artificial ice assembly comprises a plurality of artificial-ice-panels and a plurality of lateral-pins in functional combination to provide the user with a continuous loop of an ice-like surface, in preferred embodiments. Also, preferred embodiments include each of the plurality of artificial-ice-panels constructed of an ultra-high-molecular-weight polymer to provide increased longevity and durability during use, and the plurality of lateral-pins may be constructed of a steel alloy for durability and longevity. Other materials may be used, but those mentioned herein are preferred.

The ice skating training system may further include embodiments where the treadmill assembly further comprises a plurality of wheels to aid the user in moving the ice skating training system and a linear-actuator structured and arranged to increase the vertical height of one side of the treadmill assembly to provide an incline. A kit and method are also disclosed herein.

The present invention holds significant improvements and serves as an ice skating training system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ice skating training systems, constructed and operative according to the teachings of the present invention.

FIG. 1 shows a perspective view illustrating an ice skating training system during an ‘in-use’ condition showing a user training and exercising on the ice skating training system according to an embodiment of the present invention.

FIG. 2 is a perspective view illustrating the ice skating training system comprising a treadmill assembly and a harness assembly according to an embodiment of the present invention of FIG. 1.

FIG. 3 is a top-perspective view illustrating the arrangement of the components of the artificial ice assembly of the treadmill assembly according to an embodiment of the present invention of FIGS. 1-2.

FIG. 4 is a side-perspective view illustrating the artificial ice assembly of the treadmill assembly according to an embodiment of the present invention of FIGS. 1-3.

FIG. 5 is a flowchart illustrating a method of use for the ice skating training system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to exercise equipment and more particularly to a ice skating training system as used to improve ice skating exercise and training, for use in a small space without the need for ice.

Generally speaking, the ice skating training system comprises an ice skating training assembly, with the ice skating training assembly comprising a treadmill assembly and a harness assembly. Upon reading this specification, it should be appreciated that, under appropriate circumstances, considering such issues as user preferences, design preference, structural requirements, marketing preferences, cost, available materials, technological advances, etc., other ice skating training system arrangements with other components may be sufficient.

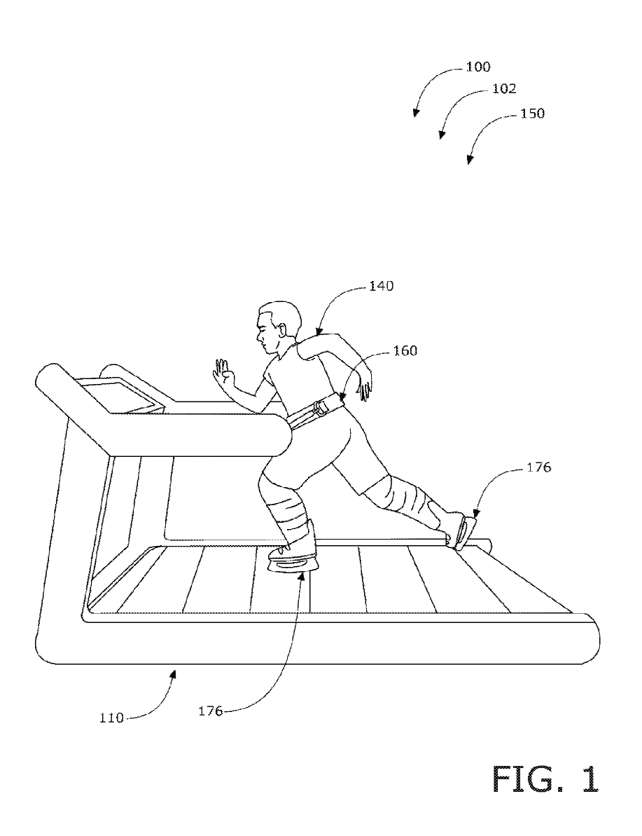

Referring to the drawings by numerals of reference there is shown in FIG. 1, ice skating training system 100 which comprises ice skating training assembly 102. Ice skating training assembly 102 may comprise treadmill assembly 110 and harness assembly 160 in functional combination. Also shown in FIG. 1, ice skating training system 100 is useful for providing an ice skating simulation for user 140 wearing ice skates 176 to practice ice skating skills without the need for frozen-water/ice.

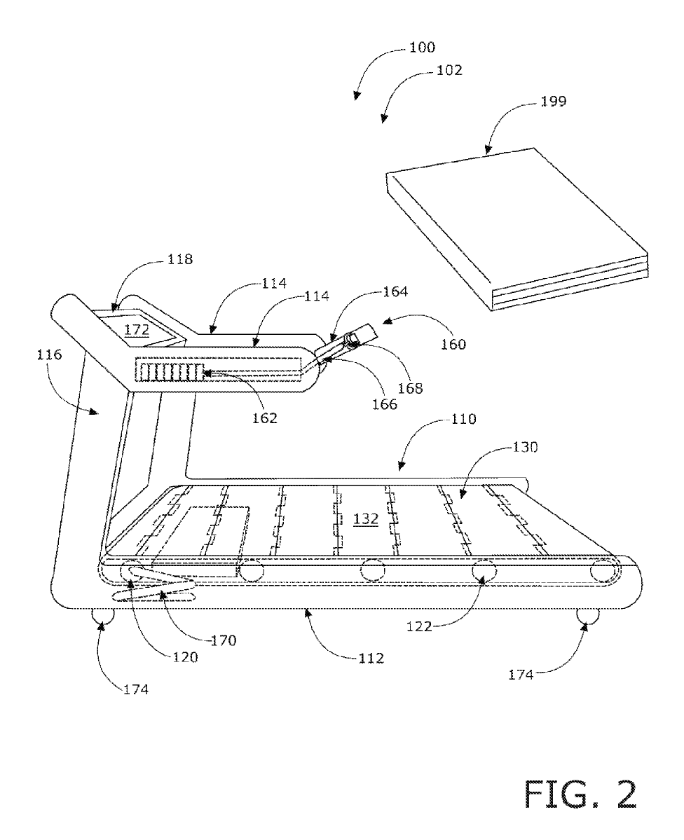

Referring now to FIG. 2, treadmill assembly 110 may comprise frame 112, side-support-bars 114, pedestal 116, computer 118, electric-motor 120, plurality of bearings 122, and artificial ice assembly 130 in functional combination. Electric-motor 120 provides rotative motion to artificial ice assembly 130; plurality of bearings 122 are structured and arranged to provide minimal resistance for artificial ice assembly 130 during use. Electric-motor 120 may operate via a 220-volt electrical supply, or other standard voltage (e.g., 120-volts, 480-volts, etc.). Each of side-support-bars 114 provide user 140 with a structural member to grasp during use such that user 140 may support his or her body weight.

Computer 118 selectively controls (as operated by user 140) the relative speed of electric-motor 120 such that user 140 operates computer 118 to select the desired speed of electric-motor 120. Also, computer 118 controls electric-motor 120 to allow user 140 to select a pre-programmed drill which may include variations of the speed of electric-motor 120 during the ‘drill’ and other forms of training. Embodiments of ice skating training assembly 102 may include computer 118 which may calculate the number of calories burned by user 140 during use, and may further calculate a distance traveled by user 140 during use. In order to provide increased functionality, computer 118 may include display 172 such that user 140 may view the distance traveled and the number of calories burned during a particular exercise event. Computer 118 may further track and calculate a whole host of information relative to the exercise in real-time and over a duration so as to track progress.

As shown in FIG. 2, harness assembly 160 may comprise variable-downward-resistance 162, body-harness 164, and safety-tether 166 in functional combination, with pedestal 116 structured and arranged to support computer 118, body-harness 164 and safety-tether 166. Safety-tether 166 may be structured and arranged to removably affix to computer 118 such that user 140 may shut off the power supply to the ice skating training system 100 by pulling on safety-tether 166. Safety-tether 166 may also include clip 168 to allow user to affix safety-tether 166 to an article of clothing worn by user 140. As can be seen in FIG. 2, treadmill assembly 110 may further include a plurality of wheels 174 to aid user 140 in moving ice skating training system 100 to an alternate location.

Embodiments of ice skating training system 100 may include variable-downward-resistance 162 comprised of resistance-rods to provide a downward force. Other embodiments may include variable-downward-resistance 162 comprising weights or comprising elastic bands to provide variable-downward-force 162.

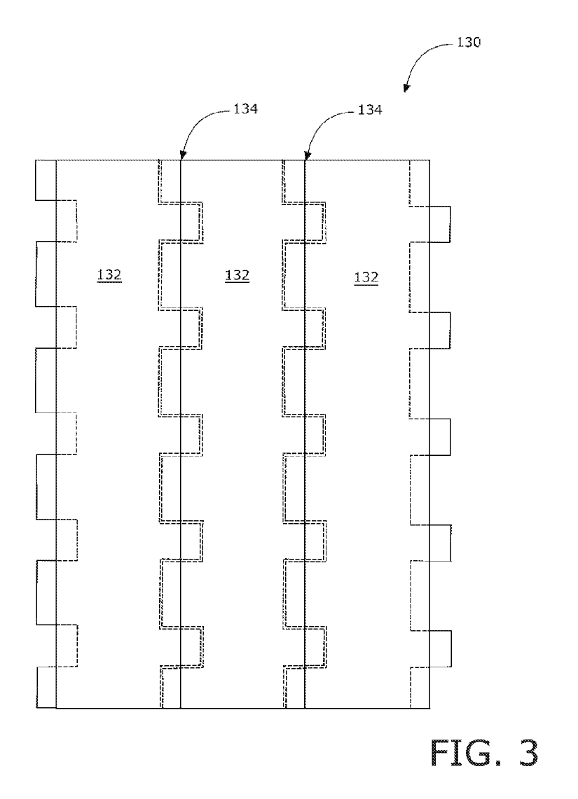

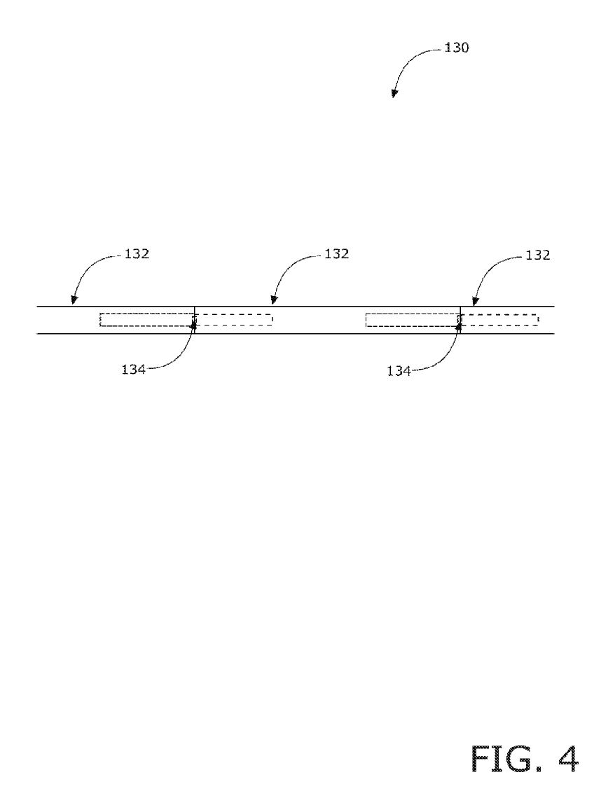

Referring now to FIGS. 3 and 4, artificial ice assembly 102 may comprise plurality of artificial-ice-panels 132 and plurality of lateral-pins 134 in functional combination, where plurality of lateral pins 134 may be constructed from a steel alloy, or other metallic compound, to provide increased durability and longevity. Artificial ice assembly 130 is structured and arranged to provide user 140 with a continuous loop of an ice-like surface (as shown in FIG. 1). Plurality of artificial-ice-panels 130 may be constructed of an ultra-high-molecular-weight polymer to provide increased longevity and durability during use.

Referring generally now to FIGS. 1-4, embodiments of treadmill assembly 130 may further comprise linear-actuator 170 structured and arranged to increase the vertical height of one side of treadmill assembly 130 to provide an incline for user 140. Embodiments may also include electric-motor 120 which may be reversible such that user 140 may practice ice skating skills in an opposite direction (i.e., skating backwards).

The ice skating training system 100 may be sold as kit comprising the following parts: at least one ice skating training assembly 102 comprising treadmill assembly 110 and harness assembly 160; at least one set of ice-skates 176; and at least one set of user instructions 199. The kit has instructions such that functional relationships are detailed in relation to the structure of the invention (such that the invention can be used, maintained, or the like in a preferred manner). The ice skating training system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different components combinations, parts may be sold separately, etc., may be sufficient.

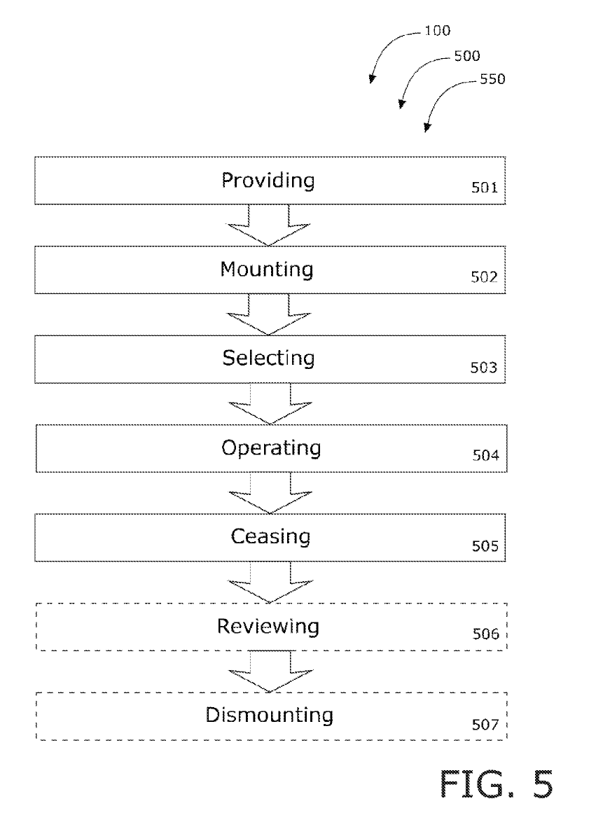

Referring now to FIG. 5, showing flowchart 550 illustrating method of use 500 for ice skating training system 100 according to an embodiment of the present invention of FIGS. 1-4. As shown, method of use 500 may comprise the steps of: step one 501, providing ice skating training assembly 102 comprising treadmill assembly 110 and harness assembly 160; step two 502, mounting ice skating training assembly 102; step three 503, selecting a pre programmed drill from computer 118; step four 504, operating treadmill assembly 110 based on the pre programmed drill; step five 505, ceasing operation of treadmill assembly 110; step six 506, reviewing a set of data provided from computer 118; and step seven 507, dismounting ice skating training assembly 102.

It should be noted that step six 506 and step seven 507 are optional steps and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An ice skating training system comprising:
an ice skating training assembly comprising;
a treadmill assembly comprising;
a frame;
a pair of side-support-bars;
a pedestal;
a computer;
an electric-motor;
a plurality of bearings; and
an artificial ice assembly comprising;
a plurality of artificial-ice-panels; and
a plurality of lateral-pins;
a harness assembly comprising;
a variable-downward-resistance;
a body-harness; and
a safety-tether.
wherein said ice skating training system comprises said ice skating training assembly;
wherein said ice skating training assembly comprise said treadmill assembly and said harness assembly in functional combination;
wherein said treadmill assembly comprises said a frame, said pair of side-support-bars, said pedestal, said computer, said electric-motor, said plurality of bearings, and said artificial ice assembly in functional combination;
wherein said artificial ice assembly comprises said plurality of artificial-ice-panels and said plurality of lateral-pins in functional combination to provide said user with a continuous loop of an ice-like surface;
wherein said pedestal is structured and arranged to support said computer, said harness assembly and said safety-tether;
wherein said safety-tether is structured and arranged to removable affix to said computer such that said user may shut off a power supply by pulling on said safety-tether;
wherein said harness assembly comprises said variable-downward resistance, said body-harness, and said safety-tether in functional combination;
wherein said electric-motor provides rotative motion to said artificial ice assembly;
wherein said plurality of bearings are structured and arranged to provide minimal resistance for said artificial ice assembly during use; and
wherein each of said pair of side-support-bars provide said user with a structural member to grasp during use.
wherein said ice skating training system is useful for providing an ice skating simulation for said user to practice ice skating skills of said user;

2. The ice skating training system of claim 1 wherein each of said plurality of artificial-ice-panels are constructed of an ultra-high-molecular-weight polymer to provide increased longevity and durability during use.

3. The ice skating training system of claim 2 wherein said treadmill assembly further comprises a linear-actuator structured and arranged to increase a vertical height of one side of said treadmill assembly to provide an incline.

4. The ice skating training system of claim 3 wherein said electric-motor is reversible such that said user may practice ice skating skills in an opposite direction.

5. The ice skating training system of claim 4 wherein said computer selectively controls a speed of said electric-motor such that said user operates said computer to select a desired speed of said electric-motor.

6. The ice skating training system of claim 5 wherein said computer controls said electric-motor to allow a user to select a pre-programmed drill which includes variations of said speed of said electric-motor during said drill.

7. The ice skating training system of claim 6 wherein said computer calculates a number of calories burned by said user during use.

8. The ice skating training system of claim 7 wherein said computer calculates a distance traveled by said user during use.

9. The ice skating training system of claim 8 wherein said computer includes a display such that said user may view said distance traveled and said number of calories burned.

10. The ice skating training system of claim 9 wherein said treadmill assembly further comprises a plurality of wheels to aid said user in moving said ice skating training system.

11. The ice skating training system of claim 10 wherein said safety-tether includes a clip to allow said user to affix said safety-tether to an article of clothing worn by said user.

12. The ice skating training system of claim 11 wherein said plurality of lateral-pins are constructed of a steel alloy for durability and longevity.

13. The ice skating training system of claim 12 wherein said electric-motor operates via a 220-volt electrical supply.

14. The ice skating training system of claim 13 wherein said variable-downward-resistance comprises resistance-rods to provide a downward force.

15. The ice skating training system of claim 13 wherein said variable-downward-resistance comprises weights to provide a downward force.

16. The ice skating training system of claim 13 wherein said variable-downward-resistance comprises elastic bands to provide a downward force.

17. An ice skating training system comprising:
an ice skating training assembly comprising;
a treadmill assembly comprising;
a frame;
a pair of side-support-bars;
a pedestal;
a computer;
an electric-motor;
a plurality of bearings; and
an artificial ice assembly comprising;
a plurality of artificial-ice-panels; and
a plurality of lateral-pins;
a harness assembly comprising;
a variable-downward-resistance;
a body-harness; and
a safety-tether.
wherein said ice skating training system comprises said ice skating training assembly;
wherein said ice skating training assembly comprise said treadmill assembly and said harness assembly in functional combination;
wherein said treadmill assembly comprises said a frame, said pair of side-support-bars, said pedestal, said computer, said electric-motor, said plurality of bearings, and said artificial ice assembly in functional combination;
wherein said artificial ice assembly comprises said plurality of artificial-ice-panels and said plurality of lateral-pins in functional combination to provide said user with a continuous loop of an ice-like surface;
wherein said pedestal is structured and arranged to support said computer, said harness assembly and said safety-tether;
wherein said safety-tether is structured and arranged to removable affix to said computer such that said user may shut off a power supply by pulling on said safety-tether;
wherein said harness assembly comprises said variable-downward resistance, said body-harness, and said safety-tether in functional combination;
wherein said electric-motor provides rotative motion to said artificial ice assembly;
wherein said plurality of bearings are structured and arranged to provide minimal resistance for said artificial ice assembly during use; and
wherein each of said pair of side-support-bars provide said user with a structural member to grasp during use.
wherein said ice skating training system is useful for providing an ice skating simulation for said user to practice ice skating skills of said user;
wherein each of said plurality of artificial-ice-panels are constructed of an ultra-high-molecular-weight polymer to provide increased longevity and durability during use;
wherein said treadmill assembly further comprises a linear-actuator structured and arranged to increase a vertical height of one side of said treadmill assembly to provide an incline;
wherein said electric-motor is reversible such that said user may practice ice skating skills in an opposite direction;
wherein said computer selectively controls a speed of said electric-motor such that said user operates said computer to select a desired speed of said electric-motor;
wherein said computer controls said electric-motor to allow a user to select a pre-programmed drill which includes variations of said speed of said electric-motor during said drill;
wherein said computer calculates a number of calories burned by said user during use;
wherein said computer calculates a distance traveled by said user during use;
wherein said computer includes a display such that said user may view said distance traveled and said number of calories burned;
wherein said treadmill assembly further comprises a plurality of wheels to aid said user in moving said ice skating training system;
wherein said safety-tether includes a clip to allow said user to affix said safety-tether to an article of clothing worn by said user;
wherein said plurality of lateral-pins are constructed of a steel alloy for durability and longevity;
wherein said electric-motor operates via a 220-volt electrical supply;
wherein said variable-downward-resistance comprises elastic bands to provide a downward force.

18. The ice skating training system of claim 17 further comprising a kit including:
said ice skating training assembly comprising;
said treadmill assembly; and
said harness assembly;
a set of ice-skates; and
a set of user installation and use instructions.

19. A method of using an ice skating training system comprising the steps of:
providing an ice skating training assembly comprising;
a treadmill assembly; and
a harness assembly;
mounting said ice skating training assembly;
selecting a pre programmed drill from a computer; and
operating said treadmill assembly based on said pre programmed drill; and
ceasing operation of said treadmill assembly.

20. The method of claim 19 further comprising the steps of:
reviewing a set of data provided from said computer; and
dis-mounting said ice skating training assembly.
